(19) United States
(12) Patent Application Publication
(10) Pub. No.: US 2025/0233947 A1
(43) Pub. Date: Jul. 17, 2025

(54) PRINT CONTROL APPARATUS, METHOD OF CONTROLLING PRINT CONTROL APPARATUS, AND STORAGE MEDIUM

(71) Applicant: CANON KABUSHIKI KAISHA, Tokyo (JP)

(72) Inventor: TAKANOBU SUZUKI, Kanagawa (JP)

(21) Appl. No.: 19/009,111

(22) Filed: Jan. 3, 2025

(30) Foreign Application Priority Data
Jan. 11, 2024 (JP) 2024-002451

(51) Int. Cl. H04N 1/00

(52) U.S. Cl. CPC H04N 1/00037; H04N 1/00076; H04N 1/00411; H04N 2201/0094

(57) ABSTRACT

A technique capable of performing printing while suppressing degradation in user convenience is provided. There are provided a movable portion whose mechanical position is movable to a plurality of positions including a first position in which a space to stack discharged print media has a predetermined size and a second position in which the space is expanded to a size greater than the predetermined size in a direction of stacking of the print media, and a control unit which performs control to make a first notification regarding movement of the movable portion to the second position during execution of printing in which printed print media are discharged to the space in a case where the movable portion is in the first position.

### BACKGROUND OF THE INVENTION

### Field of the Invention

The present invention relates to a print control apparatus, a method of controlling a print control apparatus, and a storage medium.

### Description of the Related Art

Japanese Patent Laid-Open No. 2012-056266 discloses a technique of detecting that a discharge tray is full if the number of printed print media reaches a maximum sheet stacking capacity of the discharge tray. Accordingly, in the technique disclosed in Japanese Patent Laid-Open No. 2012-056266, there is no need to provide, for example, a sensor comprising a physical mechanism for detecting that the discharge tray is full of the stacked print media and manufacturing costs can be reduced.

Incidentally, in a printing apparatus such as a multifunction peripheral having multiple functions including not only a printing function but also a scanning function or the like, it is considered that a movable portion is provided to enable movement for space saving so that the movable portion such as a scan portion is located above a sheet discharging portion to which a print medium is discharged. However, Japanese Patent Laid-Open No. 2012-056266 does not take such a printing apparatus into consideration. Thus, in a case where the technique of Japanese Patent Laid-Open No. 2012-056266 is applied to the above printing apparatus, depending on the position of the movable portion, the movable portion may inhibit a print medium from being discharged to the sheet discharging portion or make it difficult to remove a print medium from the sheet discharging portion before detection of full occupancy, which may result in deterioration of user convenience.

### SUMMARY OF THE INVENTION

The present invention has been accomplished in consideration of the above problem and provides a technique capable of performing printing while suppressing deterioration of user convenience.

A print control apparatus includes: a movable portion whose mechanical position is movable to a plurality of positions including a first position in which a space to stack discharged print media has a predetermined size and a second position in which the space is expanded to a size greater than the predetermined size in a direction of stacking of the print media; and at least one memory and at least one processor which function as: a control unit configured to perform control to make a first notification regarding movement of the movable portion to the second position during execution of printing in which printed print media are discharged to the space in a case where the movable portion is in the first position.

According to the present invention, printing can be performed while suppressing deterioration of user convenience.

Further features of the present invention will become apparent from the following description of exemplary embodiments with reference to the attached drawings.

### BRIEF DESCRIPTION OF THE DRAWINGS

FIGS. 1A and 1B are schematic configuration diagrams of a printing apparatus;

FIG. 2 is a schematic configuration diagram of a printing portion;

FIG. 3 is a diagram illustrating a jam that may occur in sheet feeding in the printing portion;

FIG. 4 is a block diagram showing a control configuration of the printing apparatus;

FIG. 5 is a flowchart showing processing contents of a printing process;

FIG. 6 is a diagram showing a notification screen notifying a message for prompting movement of a scan portion; and

FIG. 7 is a diagram showing a notification screen notifying a message for prompting removal of a print medium.

### DESCRIPTION OF THE EMBODIMENTS

An example of an embodiment of a print control apparatus, a method of controlling a print control apparatus, a program, and a storage medium will be described below with reference to the accompanying drawings. It should be noted that the following embodiment does not limit the present invention and not all combinations of features described in the embodiment are necessarily essential for solving the problem of the present invention. Further, the positions, shapes, and the like of constituent elements described in the embodiment are only shown as examples and are not intended to limit the invention to these examples.

### Configuration of Printing Apparatus

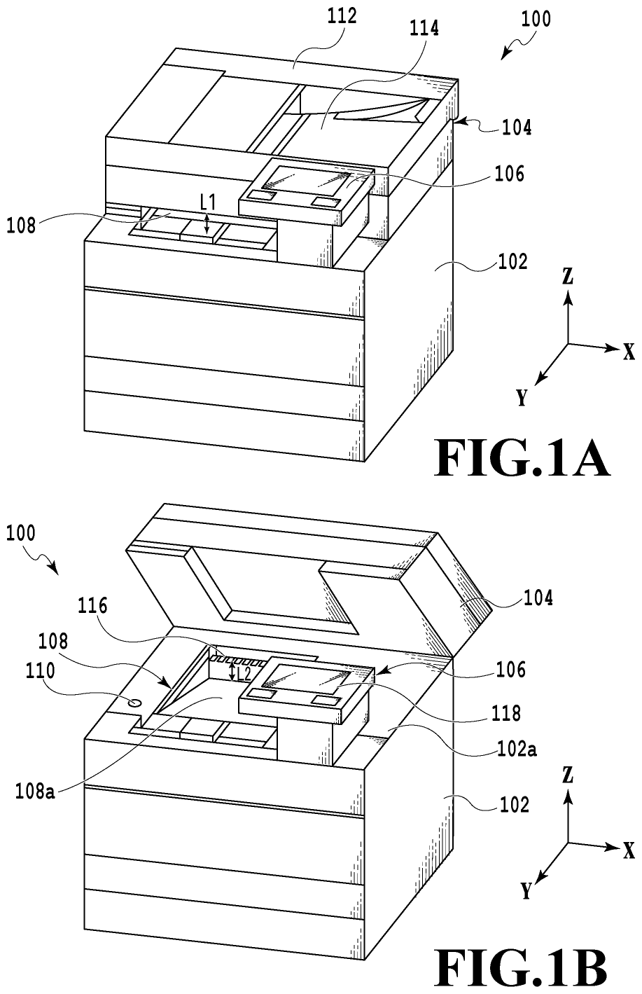

FIGS. 1A and 1B are schematic configuration diagrams of a printing apparatus; FIG. 1A is a perspective view of a state where a scan portion is in a closed position and FIG. 1B is a perspective view of a state where the scan portion is in an open position. Incidentally, it is assumed herein that in a case where the printing apparatus is viewed from a side to which a print medium is discharged after printing, a direction from left to right is an X direction, a direction from back (back side) to front (front side) is a Y direction, and a direction from below to above is a Z direction. In this manner, the X, Y, and Z directions are directions from one side to the other side and are orthogonal to one another. In the description herein, each direction is accompanied with “+(plus)” in a case where the direction is from one side to the other side, and “−(minus)” in a case where the direction is from the other side to one side, as appropriate.

A printing apparatus (also herein referred to as “print control apparatus”) 100 comprises a printing portion 102 which performs printing on a print medium, a scan portion 104 which can scan a document, and an operation portion 106 which can be operated by a user. Printing on a print medium is, for example, printing on a print sheet (medium to be printed). The printing apparatus 100 also comprises a discharge portion 108 to which a print medium is discharged after printing by the printing portion 102 and an open/close sensor 110 which can detect whether the scan portion 104 is in a closed position (described later).

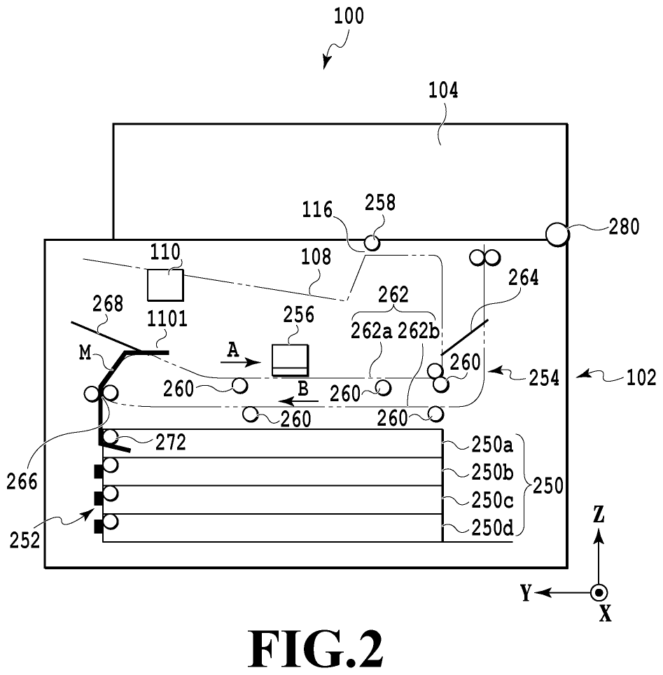

The scan portion 104 is provided rotatably via a joint 280 (see FIG. 2) at (or near) a back end of a top face 102a of the printing portion 102. For example, the joint 280 is a hinge and may have any configuration as long as the scan portion 104 can be rotatably connected to the top of the printing portion 102. The scan portion 104 thus can be located in a closed position (see FIG. 1A) to cover the top face 102a of the printing portion 102 and an open position (see FIG. 1B) to expose the top face 102a above the printing portion 102. The scan portion 104 is configured such that its position can be manually changed by a user between the closed position (also herein referred to as “first position”) and the open position (also herein referred to as “second position”). More specifically, the scan portion 104 is configured such that its mechanical position is movable to a plurality of positions including the open position and the closed position. For example, the scan portion 104 may be moved stepwise or steplessly and fixed between the closed position and the open position, or may be fixed only in the open position and the closed position. That is, at least in the open position, even in a case where a user moves the user's hand off the scan portion 104, the scan portion 104 is kept at that position without rotating and moving to the closed position under its own weight. As described above, in the printing apparatus 100, the scan portion 104 is a movable portion rotatable with respect to the printing portion 102.

In the present embodiment, the scan portion 104 comprises an ADF 112 and is configured to scan a document automatically conveyed by the ADF 112 as well as a document placed on a document platen (not shown). The detailed description of the configuration of these scan mechanisms in the scan portion 104 is omitted as various publicly-known techniques can be used. In a case where the scan portion 104 is in the open position, a document placing portion 114 of the ADF 112 is tilted relative to an XY plane. Thus, a print medium is difficult to place and may be dropped from the document placing portion 114. In contrast, in a case where the scan portion 104 is in the closed position, a print medium can be stably placed as the document placing portion 114 is substantially parallel to the XY plane.

The discharge portion 108 forms a space to stack and store a print medium discharged from a discharging port 116 in the top face 102a of the printing portion 102. The discharge portion 108 is formed in a depressed shape in the top face 102a (see FIG. 1B). In a case where the scan portion 104 is in the closed position, the upper side of the discharge portion 108 is covered with the scan portion 104 except for some areas (see FIG. 1A). In the discharge portion 108, the discharging port 116 from which a print medium is discharged is provided on the upper back side and a stacking surface 108a on which a print medium discharged from the discharging port 116 is stacked is formed to tilt upward from back to front (see FIG. 1B). In the printing apparatus 100, a print medium is discharged from the discharging port 116 in the +Y direction so that the print medium can be easily removed from the front (front side). In this manner, the positional relationship is established such that a print medium can be removed from the discharge portion 108 in front of the printing apparatus 100, not at the back, left, or right of the printing apparatus 100. Accordingly, the printing apparatus 100 can be installed without providing a space to remove a print medium at any of the back, left, and right of the printing apparatus 100. Since other devices or appliances can be installed at the back, left, and right of the printing apparatus 100 as long as there is a space in front of the printing apparatus 100, the printing apparatus 100 can be installed even in a small shop or office.

The operation portion 106 is located in front of the scan portion 104 above the printing portion 102. The operation portion 106 is provided with a display 118 which can display various kinds of information together with an operation button (not shown) which allows a user input or the like. For example, the display 118 may be a touch panel which allows a user to select a displayed button or the like with a touch of the display screen. The open/close sensor 110 adopts a photo-interrupter and detects the presence or absence of an object by detecting with a light receiver that light emitted from a light emitter is blocked by the object, that is, detects whether the scan portion 104 is in the closed position. More specifically, the open/close sensor 110 detects that the scan portion 104 is in the closed position in a case where the light is blocked by the object and detects that the scan portion 104 is not in the closed position in a case where the light is not blocked by the object. A position to install the open/close sensor 110 is not particularly limited and may be any position as long as it can detect that the scan portion 104 is in the closed position. Further, the detection system of the open/close sensor 110 is not limited to the photo-interrupter and may be any of various publicly-known detection systems. Further, the open/close sensor 110 may be configured to detect whether the scan portion 104 is in the open position instead of detecting whether the scan portion 104 is in the closed position. Alternatively, the open/close sensor 110 may be configured to detect in which of the open position and the closed position the scan portion 104 is located. Moreover, the open/close sensor 110 may be configured to detect movement of the scan portion 104 from the closed position to the open position.

### Configuration of Printing Portion

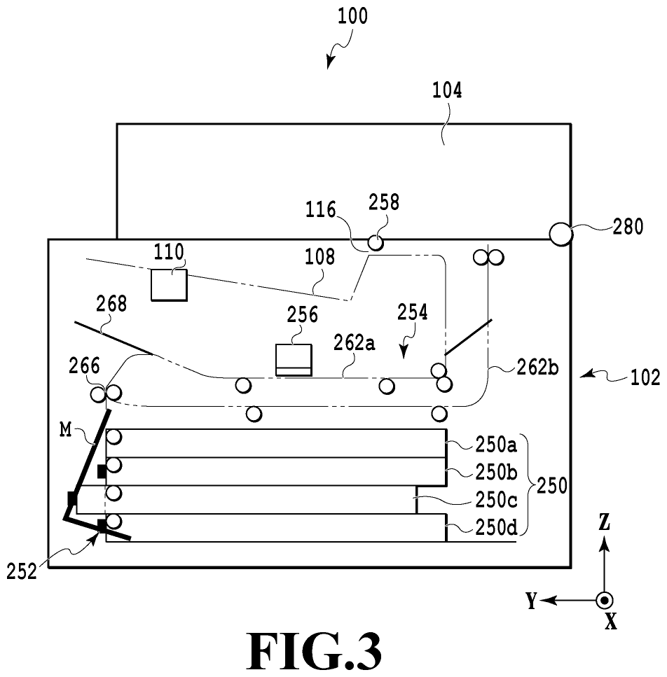

Next, the configuration of the printing portion will be described. FIG. 2 is a schematic configuration diagram of the printing portion. FIG. 3 is a diagram illustrating a state in which a cassette is pulled during conveyance of a print medium. Incidentally, FIG. 2 and FIG. 3 do not show the operation portion 106 to facilitate understanding.

The printing portion 102 comprises a cassette 250 which stores a print medium M, a feeding portion 252 which feeds a print medium M stored in the cassette 250, and a conveying portion 254 which conveys a print medium fed from the feeding portion 252. The printing portion 102 also comprises a print head 256 which performs printing on a print medium M conveyed by the conveying portion 254, and a discharge roller 258 for discharging a print medium after printing from the discharging port 116 to the discharge portion 108.

A plurality of cassettes 250 are provided, in each of which one or more print media are stacked and stored. In the present embodiment, four cassettes 250a, 250b, 250c, and 250d are provided and, for example, store different types of print media, respectively. The cassettes 250 are provided so that they are movable in the Y direction. More specifically, each cassette 250 is configured to move between a retracted position (position shown in FIG. 2) in which a stored print medium can be fed by the feeding portion 252 and a drawn position in which the cassette 250 is drawn from the retracted position in the +Y direction and can store a print medium.

The feeding portion 252 picks up the uppermost print medium M of print media M stacked and stored in each cassette 250 and feeds the picked-up print medium to the conveying portion 254 through a feeding path provided in front of the cassettes 250. Thus, in the printing portion 102, in a case where a print medium M is fed by the feeding portion 252 (that is, during printing), the cassettes 250 need to be in the retracted position. For example, a jam occurs (see FIG. 3) in a case where a cassette 250 located downstream of (above in FIG. 2) the cassette 250 storing a print medium M to be fed in the feeding path is in the drawn position or is drawn from the retracted position. Accordingly, for example, in the printing portion 102, it is preferable that the cassette 250 be in the retracted position without being drawn from the retracted position during printing (during conveyance of a print medium M).

In the conveying portion 254, a conveying path 262 is provided with a plurality of conveying rollers 260 to convey a print medium M fed from the feeding portion 252. The conveying path 262 includes a first conveying path 262a for conveying a print medium M printed by the print head 256 and a second conveying path 262b for switching a surface of a printed print medium M facing the print head 256 in the first conveying path 262a. That is, the printing portion 102 is configured to execute double-sided printing in which one side and the other side of a print medium M are printed as well as single-sided printing in which one side of a print medium M is printed.

In the first conveying path 262a, the conveying rollers 260 convey a print medium M in the arrow A direction. In the first conveying path 262a, a connection path 264 connected to the second conveying path 262b is provided downstream of the print head 256 in the arrow A direction, whereby a print medium M after printing is conveyed to the second conveying path 262b through the connection path 264. The first conveying path 262a is also connected to the discharging port 116. A print medium M not directed to the second conveying path 262b after printing is conveyed by the conveying rollers 260 and then discharged from the discharging port 116 by the discharge roller 258.

In the second conveying path 262b, the conveying rollers 260 convey a print medium M in the arrow B direction. The feeding path has a junction 266 with the second conveying path 262b. Accordingly, a print medium M conveyed through the second conveying path 262b is conveyed to the feeding path through the junction 266 and then conveyed to the first conveying path 262a.

The printing portion 102 comprises a manual feeding portion 268 through which a print medium M can be manually inserted into the conveying portion 254. A print medium M inserted through the manual feeding portion 268 enters the first conveying path 262a upstream of the print head 256 and is conveyed. Since a print medium M inserted through the manual feeding portion 268 does not pass through the feeding path in front of the cassette 250, a jam does not occur even in a case where the cassette 250 is drawn during printing. Thus, while printing is performed on a print medium M inserted through the manual feeding portion 268, the cassette 250 can be replenished with a print medium M.

In a case where print media M are stored in each cassette 250, if the cassette 250a is selected and printing is started, a pickup roller 272 corresponding to the cassette 250a picks up the uppermost one of print media M stacked and stored in the cassette 250a. The picked-up print medium M is carried upward through the feeding path to the first conveying path 262a and then subjected to a printing operation by the print head 256 based on print data while being conveyed through the first conveying path 262a in the −Y direction. The printed print medium M is conveyed through the first conveying path 262a and discharged by the discharge roller 258 in the +Y direction to the discharge portion 108 through the discharging port 116. At this time, the print medium M is discharged with its printed side down (face down). In this manner, the printing portion 102 is configured such that a print medium M after printing is discharged face down in the +Y direction to the discharge portion 108.

### Configuration of Control System of Printing Apparatus

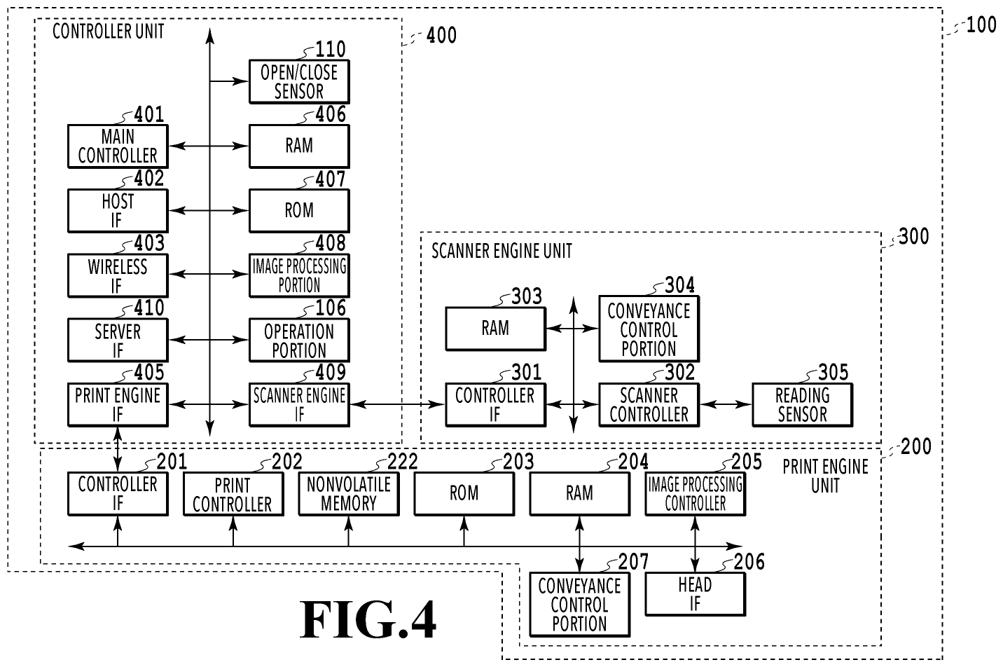

Next, the control configuration of the printing apparatus 100 will be described. FIG. 4 is a block diagram showing the control configuration of the printing apparatus 100.

The control configuration mainly comprises a print engine unit 200 which has control over the printing portion 102, a scanner engine unit 300 which has control over the scan portion 104, and a controller unit 400 which has control over the entire printing apparatus 100. The print controller 202 controls various mechanisms of the print engine unit 200 under instructions from a main controller 401 of the controller unit 400. Various mechanisms of the scanner engine unit 300 are controlled by the main controller 401 of the controller unit 400. The control configuration will be described below in detail.

In the controller unit 400, the main controller 401 formed by a CPU controls the entire printing apparatus 100 using a RAM 406 as a work area according to a program and various parameters stored in a ROM 407. For example, in a case where a print job is input, an image processing portion 408 applies predetermined image processing to received image data under instructions from the main controller 401. The print job may be input from a host PC (not shown) via a host I/F 402 or a wireless I/F 403 or input from a server (not shown) via a server I/F 410. The main controller 401 transmits the image data subjected to image processing to the print engine unit 200 via a print engine I/F 405.

The operation portion 106 is a mechanism for a user to make input/output with respect to the printing apparatus 100. A user can instruct operations such as copying and scanning, set a print mode, and see information about the printing apparatus 100 via the operation portion 106. The open/close sensor 110 is a mechanism to detect that the scan portion 104 is in the closed position. Based on the detection result of the open/close sensor 110, the main controller 401 detects whether the scan portion 104 is in the closed position.

In the print engine unit 200, the print controller 202 formed by a CPU controls various mechanisms of the printing portion 102 using a RAM 204 as a work area according to a program and various parameters stored in a ROM 203. In a case where various commands and image data are received via a controller I/F 201, the print controller 202 temporarily stores them in the RAM 204. The print controller 202 then causes an image processing controller 205 to convert the stored image data into print data so that the print head 256 can use the data for a print operation. After the print data is generated, the print controller 202 causes the print head 256 to execute a print operation based on the print data via a head I/F 206. At this time, the print controller 202 drives various rollers of the feeding portion 252 and the conveying portion 254 via a conveyance control portion 207 to convey a print medium M. Under instructions from the print controller 202, a print operation is executed by the print head 256 in conjunction with a conveyance operation of a print medium M and printing is performed on the print medium. Further, in a case where a print operation is executed based on print data, the print controller 202 starts counting the number of discharged print media at the timing of start of the print operation. More specifically, for example, the print controller 202 starts counting the number of printed print media as the number of discharged print media. This count value is monitored by the main controller 401 during a print process, which will be described later. Based on the count value, the main controller 401 detects the thickness of print media stacked on the discharge portion 108, that is, a stacked amount of print media on the discharge portion 108.

As various parameters stored in the ROM 203, for example, Nin1 (N is a natural number), double-sided printing or single-sided printing, color or monochrome printing, and photograph or text printing may be set. In a case where parameter settings for each user are applied to default settings, the print controller 202 can receive setting values input to the operation portion 106 via the print engine I/F 405 and reflect them in print settings.

In the scanner engine unit 300, the main controller 401 controls hardware of a scanner controller 302 using a RAM 406 as a work area according to a program and various parameters stored in a ROM 407. Various mechanisms of the scan portion 104 are thus controlled. For example, the main controller 401 controls the hardware of the scanner controller 302 via a controller I/F 301, whereby a document placed by a user on the document placing portion 114 of the ADF 112 is conveyed via the conveyance control portion 304 and read with a reading sensor 305. The scanner controller 302 then stores the read image data in a RAM 303. Incidentally, the print controller 202 converts the image data obtained as stated above into print data, thereby enabling the print head 256 to execute a print operation based on the image data read by the scanner controller 302. Problems Which May Arise from Configuration of Printing Apparatus

As described above, in the printing apparatus 100, a print medium M after printing is discharged in the +Y direction from the discharging port 116. The discharged print medium M is stacked on the stacking surface 108a tilting upward in the +Y direction. Further, in a case where the scan portion 104 is in the closed position, the upper side of the discharge portion 108 is covered with the scan portion 104 except for some areas.

Accordingly, in a case where the scan portion 104 is in the closed position to cover the most part of the upper side of the discharge portion 108, the thickness of print media stacked on the stacking surface 108a reaches a bottom face 104a of the scan portion 104 on the front side before reaching the height of the discharging port 116 on the back side. Thus, in a case where the scan portion 104 is in the closed position, a limit value of the number of print media that can be stacked on the stacking surface 108a is the number of print media corresponding to such a thickness that print media stacked on the stacking surface 108a reach the bottom face 104a of the scan portion 104 on the front side. In a case where print media more than the limit value are discharged from the discharging port 116, there is a high possibility of a paper jam (jam) caused by the discharged print media on the discharge portion 108.

In contrast, in a case where the scan portion 104 is in the open position, the upper side of the discharge portion 108 is exposed. Thus, print media do not reach the bottom face 104a of the scan portion 104 on the front side before reaching the height of the discharging port 116 on the back side. Accordingly, in a case where the scan portion 104 is in the open position, a limit value of the number of print media that can be stacked on the stacking surface 108a is the number of print media corresponding to such a thickness that print media stacked on the stacking surface 108a reach the discharging port 116 on the back side. As a result, the number of print media that can be stacked on the stacking surface 108a in a case where the scan portion 104 is in the open position is greater than that in a case where the scan portion 104 is in the closed position.

Further, in a case where print media stacked on the discharge portion 108 are removed, if the scan portion 104 is in the closed position, there is a high possibility that the print media M are brought into contact with the scan portion 104 covering the upper side of the discharge portion 108 and thereby folded or bent. In addition, in a case where the scan portion 104 is in the closed position, it is impossible to visually check the discharge of print media from the discharging port 116 located on the back side of the discharge portion 108. Accordingly, in a case where print media are removed from the discharge portion 108, there is a high possibility that a print medium that is being discharged contacts the hand or the print media to be removed. That is, the possibility of a jam is increased at the time of removal of print media from the discharge portion 108. As stated above, in the printing apparatus 100, discharged print media can be removed in front of the printing apparatus 100, but in a case where the scan portion 104 is in the closed position, the removability of print media from the discharge portion 108 is decreased as compared with the open position. Moreover, the possibility of a jam in the discharge portion 108 is increased.

### Printing Process

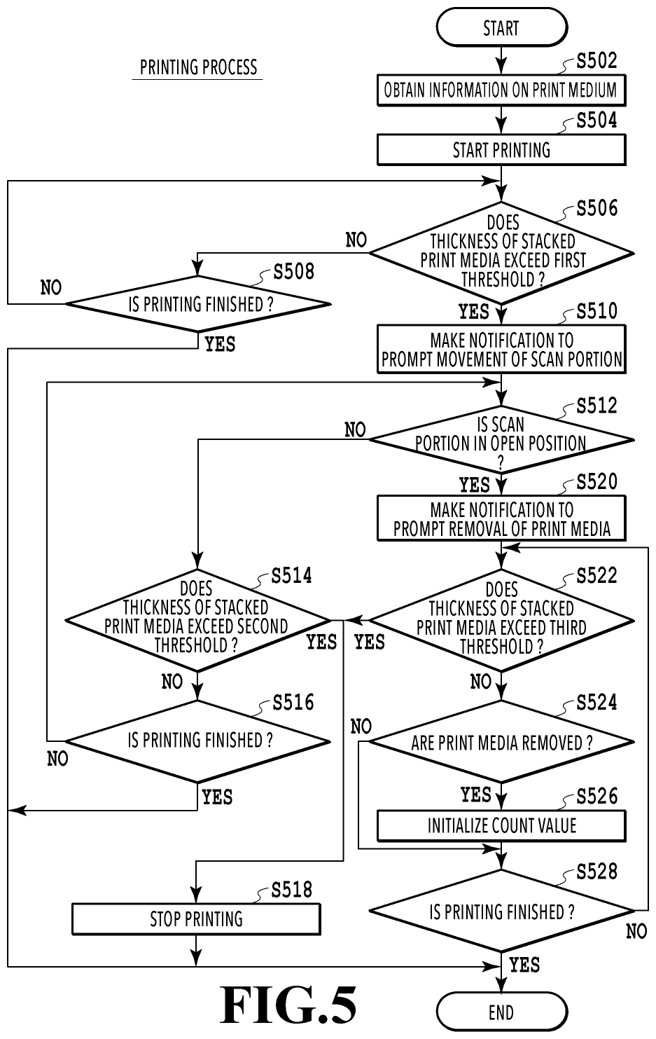

Thus, in the present embodiment, a printing process is executed to control the printing apparatus 100 so as to reduce the decrease in removability of a print medium M from the discharge portion 108 and the possibility of a jam in the discharge portion 108 during printing based on a print job. FIG. 5 is a flowchart showing detailed processing contents of the printing process for performing printing based on a print job. The procedure shown in the flowchart of FIG. 5 is executed by the main controller 401 loading a program code stored in the ROM 407 into the RAM 406 and executing the program code. Alternatively, part or all of the functions of the steps in FIG. 5 may be executed by hardware such as an ASIC or an electric circuit. In the description herein, sign S in the explanation of each process in the flowchart means a step in the flowchart.

In the printing apparatus 100, if a print job is received and an instruction is issued to start printing, a printing process is started. A print job to be an instruction to start printing is transmitted from a host PC and received by the printing apparatus 100 via the host I/F 402 or the wireless I/F 403. Alternatively, a user may generate a print job and issue an instruction to start printing by inputting, via the operation portion 106, various settings for printing using image data obtained by the scanner controller 302 and stored in the RAM 303.

If the printing process is started, the main controller 401 first obtains in S502 print medium type information and thickness information as information on a print medium for use in printing in a print job as an instruction to start printing. The print medium type information (hereinafter also simply referred to as “type information”) is information obtained from print settings included in a print job or information obtained from print settings made based on a user's input via the operation portion 106. The print medium thickness information (hereinafter also simply referred to as “thickness information”) is information indicating a thickness of one print medium and is prestored for each type of print medium in a storage area of the printing apparatus 100 such as the ROM 407.

The storage area such as the ROM 407 stores type information and information indicating a thickness of one print medium in association with each other, such as A4 plain paper: 0.009 mm, and A3 plain paper: 0.22 mm. Accordingly, in S502, thickness information corresponding to the type of print medium based on type information is obtained together with the type information. More specifically, for example, in a case where type information is “A4 plain paper,” “0.009 mm” is obtained as thickness information. Incidentally, although it is assumed here that the thickness information is stored in the storage area in the printing apparatus 100 such as the ROM 407, the thickness information is not limited to this and may be obtained from, for example, an external apparatus capable of communicating with the printing apparatus 100 (such as a server on the Internet).

Next, in S504, the main controller 401 causes the print controller 202 to execute printing based on the print job as an instruction to start printing. Thus, in the printing apparatus 100, the print controller 202 starts printing based on the print settings in the print job under the instruction from the main controller 401. In the present embodiment, it is assumed that a document placed on the document placing portion 114 is read and printed. More specifically, for example, it is assumed that single-sided printing is performed to print 100 copies of a document of 10 pages, 1,000 sheets in total.

After that, in S506, the main controller 401 determines whether a thickness of print media stacked on the discharge portion 108, namely a stacked amount of print media on the discharge portion 108, exceeds a first threshold. If the printing process is started, the main controller 401 monitors a count value of the number of print media discharged from the start of the printing operation executed by the print controller 202. Accordingly, in S506, the main controller 401 determines whether a value obtained by multiplying the count value by the thickness of one print medium (based on the thickness information obtained in S502) exceeds the first threshold. In this manner, in the present embodiment, the type of print medium is considered for the thickness (stacked amount) of print media. Incidentally, the count value is initialized at a predetermined timing such as the start or end of the printing process.

The first threshold is set at, for example, a value a certain amount less than a distance L1 (see FIG. 1A) in the vertical direction between the stacking surface 108a and the front end of the bottom face 104a of the scan portion 104 facing the stacking surface 108a in the closed position. The first threshold is set at a value less than a second threshold, which will be described later. If determines in S506 that the thickness of print media stacked on the discharge portion 108 exceeds the first thickness, the main controller 401 proceeds to S510; if determines that the thickness does not exceed the first thickness, the main controller 401 proceeds to S508 to be described later.

In the present embodiment, the thickness of print media stacked on the discharge portion 108 is detected based on the count value of the number of print media discharged after the start of the printing operation counted by the print controller 202, but is not limited to this. For example, a detection sensor to detect a print medium M may be provided close to the discharging port 116 of the first conveying path 262a and the number of print media discharged from the discharging port 116 to the discharge portion 108 may be counted based on the detection result of the detection sensor.

Alternatively, it is possible to provide a feature which directly detects the thickness (stacked amount) of print media stacked on the discharge portion 108. More specifically, the discharge portion 108 may be provided with a stacked amount sensor capable of detecting a stacked amount of stacked print media so as to determine in S506 whether the detection result of the stacked amount sensor exceeds the first threshold. The stacked amount sensor may be any of various publicly-known sensors such as an optical sensor capable of detecting the thickness of print media stacked on the stacking surface 108a, a mechanical switch capable of detecting that the thickness reaches a threshold, and a weight sensor.

In S508, the main controller 401 determines whether printing based on the print job is finished. That is, if determines in S506 that the thickness of print media stacked on the discharge portion 108 does not exceed the first threshold, the main controller 401 determines in S508 whether printing by the print controller 202 based on the print job is finished. If determines in S508 that printing by the print controller 202 is not finished, the main controller 401 returns to S506. If determines in S508 that printing by the print controller 202 based on the print job is finished, the main controller 401 finishes the printing process.

If determines in S506 that the thickness of print media stacked on the discharge portion 108 exceeds the first threshold, the main controller 401 makes a notification in S510 to prompt movement of the scan portion 104 to the open position. In the present embodiment, a document placed on the document placing portion 114 is read and 100 copies are printed by single-sided printing. Thus, the scan portion 104 should be in the closed position in the processing of S510. Accordingly, in a case where the main controller 401 determines that the thickness of print media stacked on the discharge portion 108 exceeds the first threshold, the thickness is soon to reach a value at which print media stacked on the discharge portion 108 cannot be removed or a jam occurs in the discharge portion 108 due to discharge of subsequent print media. Thus, in the present embodiment, a notification is made at this timing to prompt movement of the scan portion 104 to the open position in order to reduce the difficulty in removal of print media and the possibility of a jam. As described above, in the present embodiment, the main controller 401 functions as a control portion which performs control to make a notification regarding movement of the scan portion 104 to the open position (herein also referred to as “first notification”).

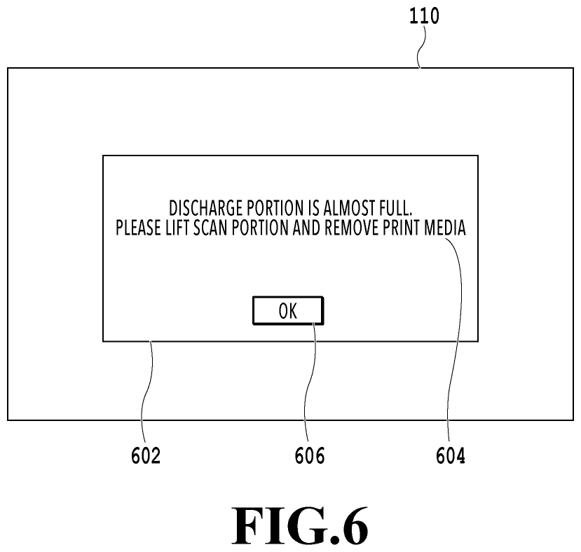

In S510, for example, the display 118 of the operation portion 106 displays a notification screen 602 which notifies a message prompting movement of the scan portion 104 to the open position (see FIG. 6). FIG. 6 is a diagram showing the notification screen 602 which notifies the message prompting movement of the scan portion 104 to the open position. The notification screen 602 displays the following text as a notification message 604: “DISCHARGE PORTION IS ALMOST FULL. PLEASE LIFT SCAN PORTION AND REMOVE PRINT MEDIA.” The notification screen 602 also displays an OK button 606. However, the notification message 604 may be any message as long as it prompts movement of the scan portion 104 to the open position. Thus, the text may be as follows: “DISCHARGE PORTION IS ALMOST FULL. PLEASE LIFT SCAN PORTION.”

A user can see from the notification message 604 on the notification screen 602 that the discharge portion 108 will become full of discharged print media unless the scan portion 104 is moved to the open position. That is, a user can recognize that the discharge portion 108 approaches a full state, which is a state where the space in the discharge portion 108 is full of discharged and stacked print media and cannot accommodate anymore as the space is reduced in the height direction due to the scan portion 104 being in the closed position. If the discharge portion 108 becomes full, there is a high possibility that a print medium discharged from the discharging port 116 gets jammed in the discharge portion 108.

A user can also see from the notification message 604 on the notification screen 602 that the above full state can be avoided by lifting the scan portion 104 to the open position. Accordingly, the notification message 604 on the notification screen 602 enables a user to recognize that the space in the discharge portion 108 is expanded in the height direction (Z direction) and the amount of print media that can be stacked on the discharge portion 108 is increased by lifting the scan portion 104 to the open position. Further, by moving the scan portion 104 to the open position, a user can easily remove the print media stacked on the discharge portion 108. A user moves the scan portion 104 to the open position in response to the notification message 604, whereby the above full state is avoided and the possibility of a jam in the discharge portion 108 is reduced.

Incidentally, as the notification regarding movement of the scan portion 104 to the open position in S510, the notification message 604 which prompts movement of the scan portion 104 to the open position is notified via the notification screen 602, but is not limited to this. The notification regarding movement of the scan portion 104 to the open position may be any notification as long as a user can recognize movement of the scan portion 104 to the open position.

More specifically, for example, the display 118 may display an icon, pictogram, animation, or moving image indicating movement of the scan portion 104 to the open position. Further, for example, a speaker (not shown) or the like may send an audio message which prompts movement of the scan portion 104 to the open position. Further, for example, a character string such as “scan portion” or a symbol may be highlighted or flashed on and off on the display 118. Further, for example, the scan portion 104 may be provided with a light emitter which emits light in a specific light emitting aspect (for example, a flash in a color showing an error state).

After a user moves the scan portion 104 to the open position, if the OK button 606 is selected (pressed), the main controller 401 determines that the scan portion 104 has been moved to the open position by a user and finishes displaying the notification screen 602 on the display 118.

Returning to FIG. 5, in subsequent S512, the main controller 401 determines whether the scan portion 104 has been moved to the open position. In the present embodiment, the open/close sensor 110 can determine whether the scan portion 104 is in the closed position. Accordingly, in S512, if determines that the scan portion 104 is not in the closed position based on the detection result of the open/close sensor 110, the main controller 401 determines that the scan portion 104 has been moved to the open position by a user. If determines that the scan portion 104 is in the closed position, the main controller 401 determines that the scan portion 104 has not been moved to the open position by a user. In this manner, in the present embodiment, the open/close sensor 110 functions as a detection portion capable of detecting the position of the scan portion 104.

If determines in S512 that the scan portion 104 has been moved to the open position, the main controller 401 proceeds to S520 to be described later; if determines that the scan portion 104 has not been moved to the open position, the main controller 401 proceeds to S514 to be described later. Incidentally, the method of determining that the scan portion 104 has been moved to the open position in S512 is not limited to the determination based on the detection result of the open/close sensor 110. For example, the main controller 401 may determine that the scan portion 104 has been moved to the open position if the main controller 401 determines that the scan portion 104 is not in the closed position based on the detection result of the open/close sensor 110 and the OK button 606 is selected.

In S514, the main controller 401 determines whether the thickness of print media stacked on the discharge portion 108, namely the stacked amount of print media on the discharge portion 108, exceeds a second threshold. In S514, the main controller 401 determines whether a value obtained by multiplying the count value indicating the number of discharged print media counted in the print controller 202 by the thickness of one print medium exceeds the second threshold. The second threshold is set at a lower limit value of such an amount that print media are not appropriately stacked on the discharge portion 108 while the scan portion 104 is in the closed position, or a value a predetermined amount less than the lower limit value. Incidentally, examples of the case where “print media are not appropriately stacked on the discharge portion 108 while the scan portion 104 is in the closed position” include a jam in the discharge portion 108. More specifically, the second threshold is set at, for example, a value corresponding to the distance L1 (see FIG. 1A) in the vertical direction between the stacking surface 108a and the front end of the bottom face 104a of the scan portion 104 facing the stacking surface 108a in the closed position, or a value a predetermined amount less than the distance L1. The second threshold is greater than the first threshold. If determines in S514 that the thickness of print media stacked on the discharge portion 108 exceeds the second thickness, the main controller 401 proceeds to S518 to be described later; if determines that the thickness does not exceed the second thickness, the main controller 401 proceeds to S516 to be described below.

In S516, the main controller 401 determines whether printing based on the print job by the print controller 202 is finished. If determines in S516 that printing based on the print job by the print controller 202 is not finished, the main controller 401 returns to S512. If determines in S516 that printing based on the print job by the print controller 202 is finished, the main controller 401 finishes the printing process.

In S518, the main controller 401 stops printing based on the print job and finishes the printing process. That is, if determines in S514 that the thickness of print media stacked on the discharge portion 108 exceeds the second threshold, the main controller 401 causes in S518 the print controller 202 to stop printing in execution based on the print job. The discharge of print media to the discharge portion 108 is thus stopped and the possibility of a jam in the discharge portion 108 can be reduced. As described above, in the present embodiment, the main controller 401 functions as a control portion which performs control such that printing in execution is stopped according to the stacked amount of print media on the discharge portion 108.

If determines in S512 that the scan portion 104 has been moved to the open position, the main controller 401 makes a notification in S520 which prompts removal (taking away) of the print media stacked on the discharge portion 108 (herein also referred to as “second notification”). At the stage of the processing of S520, print media are stacked on the discharge portion 108 to the thickness more than or equal to the first threshold. Thus, prompting a user to remove the print media from the discharge portion 108 at this stage can reduce the possibility of a jam caused by a print medium discharged subsequently in the discharge portion 108 and a drop of the stacked print media from the discharge portion 108.

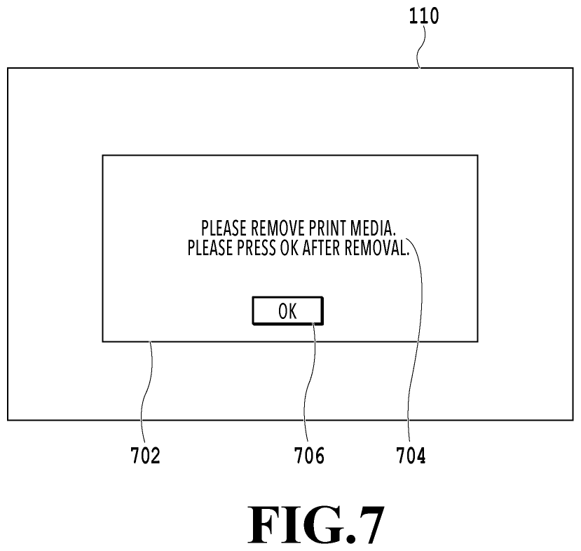

In S520, for example, the display 118 of the operation portion 106 displays a notification screen 702 which notifies a message prompting removal of the print media stacked on the discharge portion 108 from the discharge portion 108 (see FIG. 7). FIG. 7 is a diagram showing the notification screen 702 which notifies the message prompting removal of the print media stacked on the discharge portion 108 from the discharge portion 108. The notification screen 702 displays the following text as a notification message 704: “PLEASE REMOVE PRINT MEDIA. PLEASE PRESS OK AFTER REMOVAL.” The notification screen 702 also displays an OK button 706.

A user can see from the notification message 704 on the notification screen 702 that the stacked print media need to be removed from the discharge portion 108. If a user notified of the notification message 704 removes the stacked print media from the discharge portion 108, print media can be prevented from being stacked to an amount which disables appropriate stacking on the discharge portion 108. The amount which disables appropriate stacking on the discharge portion 108 is, for example, such an amount that stacked print media drop or protrude from the discharge portion 108, such an amount that a jam occurs in the discharge portion 108, or an amount with a high possibility thereof.

Incidentally, the notification prompting removal of print media stacked on the discharge portion 108 is not limited to the notification message 704 sent to a user via the notification screen 702. For example, the display 118 may display an icon, pictogram, animation, or moving image indicating removal of stacked print media from the discharge portion 108. Further, for example, a speaker (not shown) or the like may send an audio message which prompts removal of the print media stacked on the discharge portion 108. Further, the discharge portion 108 may be provided with a light emitter which emits light in a specific light emitting aspect (for example, a flash in a color showing an error state).

If a user selects (presses) the OK button 706, the main controller 401 determines that the print media stacked on the discharge portion 108 are removed by the user and finishes displaying the notification screen 702 on the display 118.

Returning to FIG. 5, in subsequent S522, the main controller 401 determines whether the thickness of print media stacked on the discharge portion 108, namely the stacked amount of print media on the discharge portion 108, exceeds a third threshold greater than the second threshold. That is, in the present embodiment, after the notification is made to prompt movement of the scan portion in S510, in a case where the main controller 401 determines in S512 that the scan portion is in the open position, printing is continued even if the stacked amount of print media in the discharge portion 108 exceeds the second threshold.

In S522, the main controller 401 determines whether a value obtained by multiplying the count value indicating the number of discharged print media counted by the print controller 202 by the thickness of one print medium exceeds the third threshold. The third threshold is set at a lower limit value of such an amount that print media are not appropriately stacked on the discharge portion 108 while the scan portion 104 is in the open position, or a value a predetermined amount less than the lower limit value. Incidentally, examples of the case where “print media are not appropriately stacked on the discharge portion 108 while the scan portion 104 is in the open position” include a drop or protrusion of print media from the discharge portion 108 and a jam in the discharge portion 108. More specifically, the third threshold is set at, for example, a value corresponding to a distance L2 (see FIG. 1B) in the vertical direction between the discharging port 116 and the back end of the stacking surface 108a, or a value a predetermined amount less than the distance L2. The third threshold is greater than the first threshold and the second threshold. That is, the thresholds used in the printing process are set such that “first threshold <second threshold <third threshold.”

If determines in S522 that the thickness of print media stacked on the discharge portion 108 exceeds the third threshold, the main controller 401 proceeds to S518 and stops printing in execution based on the print job. The discharge of print media to the discharge portion 108 is thus stopped and print media are prevented from being stacked to an amount which disables appropriate stacking in the discharge portion 108. That is, the possibility that stacked print media drop or protrude from the discharge portion 108 or a jam occurs in the discharge portion 108 can be reduced.

If determines in S522 that the thickness of print media stacked on the discharge portion 108 does not exceed the third threshold, the main controller 401 proceeds to S524. In S524, the main controller 401 determines whether the stacked print media are removed from the discharge portion 108. In S524, the main controller 401 determines whether the OK button 706 is selected. That is, if determines in S524 that the OK button 706 is selected, the main controller 401 determines that the stacked print media are removed from the discharge portion 108; if determines that the OK button 706 is not selected, the main controller 401 determines that the stacked print media are not removed from the discharge portion 108. If determines in S524 that the stacked print media are removed from the discharge portion 108, the main controller 401 proceeds to S526 to be described below; if determines that the stacked print media are not removed, the main controller 401 proceeds to S528 to be described below.

In S526, the main controller 401 initializes the count value indicating the number of discharged print media counted by the print controller 202 and proceeds to S528. In S528, the main controller 401 determines whether printing based on the print job by the print controller 202 is finished. If determines in S528 that printing based on the print job by the print controller 202 is not finished, the main controller 401 returns to S522. If determines in S528 that printing based on the print job by the print controller 202 is finished, the main controller 401 finishes the printing process.

### Effect and Advantage

As described above, in the printing apparatus 100, in a case where the stacked amount of print media in the discharge portion exceeds the first threshold while the scan portion is in the closed position, a notification is made to prompt movement of the scan portion to the open position. A user can thus recognize the necessity to move the scan portion 104 to the open position. By a user moving the scan portion 104 to the open position, print media can be stacked without a jam in the discharge portion 108. Further, at the time of removal of print media from the discharge portion 108, the print media can be smoothly removed without being obstructed by the scan portion 104. Moreover, at the time of removal of stacked print media, the possibility that a hand or removed print media contact a print medium being discharged can be reduced. That is, the possibility of a jam can be reduced at the time of removal of stacked print media from the discharge portion 108. By the above effect and advantage, the printing apparatus 100 can smoothly perform printing, reduce the deterioration of user convenience, and suppress the increase of time required for printing.

### Other Embodiments

The above embodiment can be modified as shown in (1) to (7) below.

(1) Although not particularly described in the above embodiment, various kinds of control described as being executed by the main controller 401 in the printing process may be executed by a single piece of hardware or may be shared between a plurality of pieces of hardware (for example, a plurality of processors or circuits). Further, although the present invention has been described in detail based on its preferred embodiment in the above embodiment, the present invention is not limited to this specific embodiment and includes various embodiments within a scope not deviating from the gist of the present invention. Further, the above embodiment only shows an embodiment of the present invention. Further, although it has been described as an example in the above embodiment that the present invention is applied to a printing apparatus as a multifunction peripheral comprising a reading apparatus, the application of the present invention is not limited to such a printing apparatus. For example, the present invention is applicable to a processing apparatus provided with a movable portion which covers at least a part of the upper side of a discharge portion in which processed matters are discharged and stacked after processing.

(2) In the above embodiment, the scan portion 104 has been described as an example of the movable portion covering the discharge portion 108 in the printing apparatus 100. However, the movable portion in the printing apparatus to which the present invention is applicable is not limited to the scan portion and may be any member which is movable and covers at least a part of the discharge portion.

(3) In the above embodiment, if it is determined in S514 that the thickness of print media stacked on the discharge portion 108 exceeds the second threshold, printing is stopped in S518 and the printing process is finished. However, the process is not limited to this. After printing is stopped in S518, if print media are removed from the discharge portion 108 and an instruction to restart printing is issued by a user operation, the count value in the print controller 202 may be initialized and printing may be restarted. In this case, after printing is stopped in S518, the display 118 displays, for example, a content of processing to be executed by a user to restart printing and a button to restart printing. The content of processing to be executed by a user is, for example, at least one of the movement of the scan portion to the open position and the removal of print media stacked on the discharge portion 108.

(4) In the above embodiment, the main controller 401 provided in the printing apparatus 100 notifies the notification screens 602 and 702 according to the position of the scan portion and whether print media are removed from the discharge portion, but is not limited to this. Further, in the above embodiment, the main controller 401 provided in the printing apparatus 100 stops printing according to the stacked amount of print media on the discharge portion, but is not limited to this. An external apparatus provided separately from the printing apparatus 100 may control the execution of the notification of the notification screens 602 and 702 according to the position of the scan portion and whether print media are removed from the discharge portion and the stop of printing according to the stacked amount of print media. In this case, the notification screens 602 and 702 may be displayed also on a display of the external apparatus.

(5) Although not particularly described in the above embodiment, in the printing process, it may be determined whether the scan portion 104 is in the open position (that is, not in the closed position) after printing is started in S504. In this case, in the determination, if it is determined that the scan portion 104 is not in the open position, the process proceeds to S506; if it is determined that the scan portion 104 is in the open position, the process proceeds to S520.

(6) Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

(7) The above embodiment and various modifications shown in (1) to (6) above may be combined as appropriate.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-002451, filed Jan. 11, 2024, which is hereby incorporated by reference wherein in its entirety.

What is claimed is:

1. A print control apparatus comprising:
a movable portion whose mechanical position is movable to a plurality of positions including a first position in which a space to stack discharged print media has a predetermined size and a second position in which the space is expanded to a size greater than the predetermined size in a direction of stacking of the print media; and
at least one memory and at least one processor which function as:
a control unit configured to perform control to make a first notification regarding movement of the movable portion to the second position during execution of printing in which printed print media are discharged to the space in a case where the movable portion is in the first position.

2. The print control apparatus according to claim 1, further comprising a detector configured to detect a position of the movable portion,
wherein the control unit performs control to make the first notification based on a detection result of the detector.

3. The print control apparatus according to claim 1,
wherein the first notification is a notification which prompts a user to move the movable portion to the second position.

4. The print control apparatus according to claim 1,
wherein in a case where the movable portion is in the first position and a stacked amount of print media discharged to the space exceeds a first threshold during execution of the printing, the control unit performs control to make the first notification.

5. The print control apparatus according to claim 4,
wherein after the first notification is made, in a case where the stacked amount exceeds a second threshold greater than the first threshold with the movable portion unmoved to the second position, the control unit performs control to stop the printing.

6. The print control apparatus according to claim 5,
wherein after the first notification is made, in a case where the movable portion is moved to the second position, the control unit performs control to continue the printing even if the stacked amount exceeds the second threshold.

7. The print control apparatus according to claim 6,
wherein after the first notification is made, in a case where the movable portion is moved to the second position and the stacked amount exceeds a third threshold greater than the second threshold, the control unit performs control to stop the printing.

8. The print control apparatus according to claim 1,
wherein after the first notification is made, in a case where the movable portion is moved to the second position, the control unit performs control to make a second notification which prompts removal of print media stacked in the space from the space.

9. The print control apparatus according to claim 4,
wherein in a case where a predetermined operation is performed, the control unit initializes the stacked amount.

10. The print control apparatus according to claim 4,
wherein the stacked amount is obtained based on a number of discharged print media.

11. The print control apparatus according to claim 10,
wherein the stacked amount is obtained further based on a type of print medium.

12. The print control apparatus according to claim 4, further comprising a detector configured to detect a position of the movable portion,
wherein in a case where the printing is started, if the detector detects that the movable portion is in the second position, the control unit does not make the first notification even if the stacked amount exceeds the first threshold.

13. The print control apparatus according to claim 2,
wherein in a case where the printing is started, if the detector detects that the movable portion is in the second position, the control unit performs control to make a second notification which prompts removal of stacked print media from the space.

14. The print control apparatus according to claim 1,
wherein the movable portion is a scan portion configured to read a document.

15. The print control apparatus according to claim 1,
wherein the printing is printing on the print media.

16. A method of controlling a print control apparatus, the print control apparatus comprising a movable portion whose mechanical position is movable to a plurality of positions including a first position in which a space to stack discharged print media has a predetermined size and a second position in which the space is expanded to a size greater than the predetermined size in a direction of stacking of the print media,
the method comprising:
performing control to make a first notification regarding movement of the movable portion to the second position during execution of printing in which printed print media are discharged to the space in a case where the movable portion is in the first position.

17. A non-transitory computer readable storage medium storing a program for causing a computer to function as a control unit of a print control apparatus, the print control apparatus comprising a movable portion whose mechanical position is movable to a plurality of positions including a first position in which a space to stack discharged print media has a predetermined size and a second position in which the space is expanded to a size greater than the predetermined size in a direction of stacking of the print media, wherein the control unit performs control to make a first notification regarding movement of the movable portion to the second position during execution of printing in which printed print media are discharged to the space in a case where the movable portion is in the first position.
